(19) United States
(12) Patent Application Publication
(10) Pub. No.: US 2014/0134466 A1
(43) Pub. Date: May 15, 2014

(54) SOLID BATTERY

(71) Applicants: Yushi Suzuki, Susono-shi (JP); Tomoya Suzuki, Kariya-shi (JP)

(72) Inventors: Yushi Suzuki, Susono-shi (JP); Tomoya Suzuki, Kariya-shi (JP)

(73) Assignee: TOYOTA JIDOSHA KABUSHIKI KAISHA, Toyota-shi, Aichi (JP)

(21) Appl. No.: 14/129,721

(22) PCT Filed: Aug. 5, 2011
(86) PCT No.: PCT/JP2011/067937

§ 371 Date: Dec. 27, 2013

(51) Int. Cl. H01M 10/654

(52) U.S. Cl. CPC H01M 10/5042
USPC 429/72; 429/163

(57) ABSTRACT

Provided is a solid battery which can inhibit degradation. The present invention is a solid battery including an electrode body having a pair of electrode layers and a solid electrolyte layer disposed between the pair of electrode layers and an exterior body which houses the electrode body, wherein a water absorbent is provided inside the exterior body, and a heat insulating material is disposed between the water absorbent and the electrode body.

### TECHNICAL FIELD

The present invention relates to a solid battery using a solid electrolyte.

### BACKGROUND ART

A lithium-ion secondary battery (hereinafter sometimes referred to as “lithium secondary battery”) has a characteristic that it has a higher energy density and is operable at a high voltage compared to other secondary batteries. Therefore, it is used for information devices such as cellular phones, as a secondary battery which can be easily reduced in size and weight, and nowadays there is also an increasing demand for the lithium-ion secondary battery to be used as a power source for large-scale apparatuses such as electric vehicles and hybrid vehicles.

The lithium-ion secondary battery comprises a cathode layer, an anode layer, and an electrolyte layer disposed between them. An electrolyte to be employed in the electrolyte layer is, for example, a non-aqueous liquid or a solid. When the liquid is used as the electrolyte (hereinafter, the liquid being referred to as an “electrolytic solution”), it permeates into the cathode layer and the anode layer easily. Therefore, an interface can be formed easily between the electrolytic solution and active materials contained in the cathode layer and the anode layer respectively, and the battery performance can be easily improved. However, since commonly used electrolytic solutions are flammable, it is necessary to mount a system to ensure safety. On the other hand, since electrolytes in solid form (hereinafter referred to as “solid electrolyte”) are nonflammable, when the solid electrolyte is applied, the above system can be simplified. As such, lithium-ion secondary batteries having a layer containing a solid electrolyte have been suggested. (hereinafter, the layer being referred to as “solid electrolyte layer” and the battery being referred to as “solid battery” or “all solid lithium-ion secondary battery”).

As a technique related to such a solid battery, Patent Document 1 discloses an all solid lithium-ion secondary battery comprising an electrode body sealed off in an exterior body and having a laminated body in which at least a cathode layer, a solid electrolyte layer and an anode layer are laminated in this order, the battery has a cooling device and a water removing agent which absorbs water trapped by the cooling device in the exterior body.

### CITATION LIST

### Patent Literatures

Patent Document 1: Japanese Patent Application Laid-Open Publication No. 2008-287970

### SUMMARY OF THE INVENTION

### Problems to be Solved by the Invention

According to the technique disclosed in Patent Document 1, since it has a cooling device and a water removing agent in the exterior body, it is considered that ingress of water into the electrode body can be prevented under a circumstance in which water removing performance of the water removing agent is efficiently exerted. However, if the temperature of the electrode body being cooled by the cooling device increases, the water removing performance of the water removing agent declines. If the water removing performance of the water removing agent declines, water enters inside the electrode body, and the water entered inside the electrode body and the solid electrolyte react to each other, thereby the battery tends to degrade. Therefore, according to the technique disclosed in Patent Document 1, the effect of preventing degradation of the battery tends to be insufficient.

Accordingly, an object of the present invention is to provide a solid battery which can inhibit degradation.

### Means for Solving the Problems

In order to solve the above problems, the present invention takes the following means.

Namely, a first aspect of the present invention is a solid battery comprising: an electrode body having a pair of electrode layers and a solid electrolyte layer disposed between the pair of electrode layers; and an exterior body which houses the electrode body, wherein a water absorbent is provided inside the exterior body and a heat insulation material is disposed between the water absorbent and the electrode body.

Here, in the first aspect of the present invention and other aspects of the present invention shown below (hereinafter, collectively referred to as “the present invention”), the “pair of electrode layers” refers to a cathode layer containing a cathode active material and an anode layer containing an anode active material. Also, in the first aspect of the present invention, the “heat insulation material” refers to a heat insulation material having air permeability.

In the first aspect of the present invention, the heat insulation material is disposed between the water absorbent and the electrode body. Therefore, even if the temperature of the electrode body increases, it is possible to inhibit temperature increase of the water absorbent. Inhibiting temperature increase of the water absorbent enables to inhibit degradation of the water absorption performance of the water absorbent, thus a situation in which the solid electrolyte included in the electrode body and water react to each other can be inhibited. Since inhibiting the situation in which the solid electrolyte and water react to each other makes it possible to inhibit degradation of the battery, according to the first aspect of the present invention, it is possible to provide a solid battery which can inhibit degradation.

Also, in the first aspect of the preset invention, it is preferable that the water absorbent and the electrode body are disposed in a manner to be in parallel to the lamination direction of each layer which configures the electrode body.

The electrode body is easy to produce heat in the lamination direction of each layer which configures the electrode body. Therefore, disposing the water absorbent and the electrode body in a manner to be in parallel to the lamination direction of each layer which configures the electrode body makes it easy to inhibit temperature increase of the water absorbent. As a result, it becomes easy to inhibit degradation of the solid battery.

Also, in the first aspect of the present invention described above, a fluid circulation pathway may be connected to the exterior body, a fluid may circulate inside the exterior body and the fluid circulation pathway, and a water absorbent may be disposed inside the fluid circulation pathway.

Even if the temperature of the electrode body increases, it is more difficult to increase the temperature in the fluid circulation pathway connected to the exterior body than the temperature in the exterior body. Therefore, the water absorption performance of the water absorbent disposed inside the fluid circulation pathway does not degrade easily. Since maintaining the water absorption performance of the water absorbent makes it possible to inhibit degradation of the battery, it is possible to inhibit degradation of the solid battery easily by disposing the water absorbent in the fluid circulation pathway. Further, disposing the water absorbent in the fluid circulation pathway as well makes it possible to maintain the water absorption performance of the water absorbent by inhibiting the temperature increase of the water absorbent disposed in the fluid circulation pathway even when the solid battery is heated up and used in order to decrease the resistance. Therefore, disposing the water absorbent in the fluid circulation pathway makes it possible to inhibit the degradation of the solid battery even when the solid battery is heated up to use.

A second aspect of the present invention is a solid battery comprising: an electrode body having a pair of electrode layers and a solid electrolyte layer disposed between the pair of electrode layers; and an exterior body which houses the electrode body, wherein a fluid circulation pathway is connected to the exterior body, a fluid flows inside the exterior body and the fluid circulation pathway, and a water absorbent is disposed inside the fluid circulation pathway.

In the second aspect of the present invention, the water absorbent is disposed inside the fluid circulation pathway connected to the exterior body which houses the electrode body. Disposing the water absorbent inside the fluid circulation pathway in which fluid circulates makes it possible to absorb water efficiently. Here, in the fluid circulation pathway, the temperature is more difficult to increase than in the exterior body which houses the electrode body, thereby the water absorption performance of the water absorbent disposed in the fluid circulation pathway does not degrade easily. Since maintaining the water absorption performance of the water absorbent makes it easy to inhibit degradation of the battery, according to the second aspect of the present invention, it is possible to provide a solid battery which can inhibit degradation. Further, according to the second aspect of the present invention, it is possible to inhibit temperature increase of the water absorbent thereto maintain the water absorption performance of the water absorbent by disposing the water absorbent inside the fluid circulation pathway even if the battery is heated and used to decrease the resistance. Therefore, according to the second aspect of the present invention, it is possible to provide a solid battery which can inhibit degradation even when the battery is purposely heated to use.

Also, in the first or second aspect of the present invention, the solid electrolyte layer preferably contains a sulfide-based solid electrolyte. In such a configuration as well, it is possible to provide a solid battery which can inhibit degradation.

### Effects of the Invention

According to the present invention, it is possible to provide a solid battery which can inhibit degradation.

### BRIEF DESCRIPTION OF THE DRAWINGS

FIG. 1 is a graph showing a relationship between dew point and temperature.

FIG. 2 is a view describing a solid battery 10.

FIG. 3 is a view describing a solid battery 20.

FIG. 4 is a view describing a solid battery 30.

FIG. 5 is a graph describing the difference in dew point by the water absorbents.

FIG. 6 is a graph describing the difference in battery performance by dew points.

### MODES FOR CARRYING OUT THE INVENTION

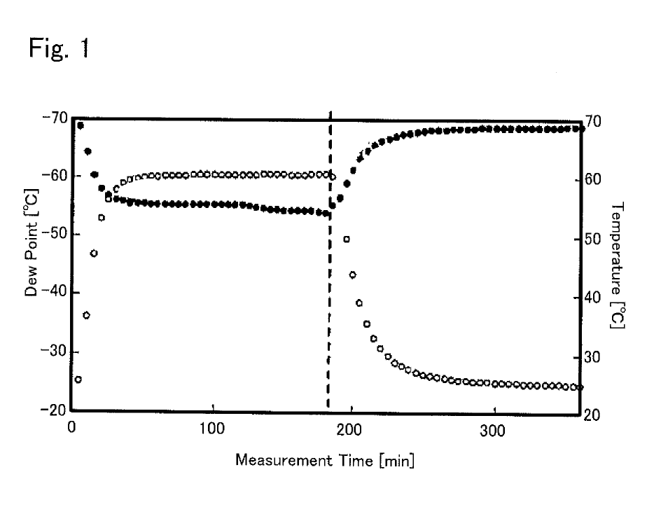

The inventors of the present invention examined the relationship between the dew point and the temperature of a water absorption (hereinafter also referred to as “hygroscopic agent”). In particular, as a hygroscopic agent, 25 g of zeolite (Molecular Sieves 3A, manufactured by Nacalai Tesque, INC.) subjected to vacuum drying at a temperature of 280° C. for 8 hours was put in a 200 ml glass container to which a dew-point meter was attached in advance then the container was sealed off. Next, the temperature environment was increased from 25° C. to 60° C. while measuring the dew point in the glass container. Further, after 3 hours passed since the measuring of the dew point in the glass container had started, the temperature environment was decreased from 60° C. to 25° C. The dew point and the temperature are shown in FIG. 1. The vertical axis on the left side in FIG. 1 represents the dew point [° C.], the vertical axis on the right side in FIG. 1 represents the temperature [° C.], and the horizontal axis represents the measuring time [min]. In FIG. 1, “” shows the measured results of the dew point and “◯” shows the measured results of the temperature.

As shown in FIG. 1, when the temperature was increased from 25° C. to 60° C., the dew point increased, and when the temperature was decreased from 60° C. to 25° C., the dew point decreased. That is, there was a correlation between the temperature of the hygroscopic agent and the water absorption performance, and as the temperature environment became higher, the water absorption performance of the hygroscopic agent became decreased. From this result, the inventors of the present invention completed the present invention by finding out that inhibiting temperature increase of the hygroscopic agent makes it possible to inhibit degradation of the water absorption performance of the hygroscopic agent, as a result it is possible to inhibit degradation of the solid battery.

Hereinafter, the present invention will be described with reference to the drawings. It should be noted, however, that the embodiments shown below are examples of the present invention and the present invention is not limited to these embodiments.

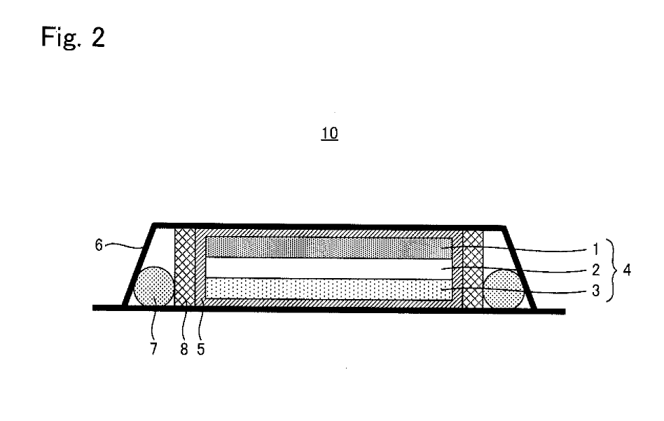

FIG. 2 is a cross-sectional view describing a solid battery 10 of the present invention according to the first embodiment. Top-and-bottom direction of the drawing sheet of FIG. 2 is the lamination direction of each layer which configures an electrode body 4. In FIG. 2, a water absorbent 7 and a heat insulating material 8 are shown being simplified. As shown in FIG. 2, the solid battery 10 comprises: an electrode body 4 having a cathode layer 1, an anode layer 3, and a solid electrolyte layer 2 disposed between the cathode layer 1 and the anode layer 3; a sealing material 5 to seal off the electrode body 4; and an exterior body 6 which houses the electrode body 4 sealed off by the sealing material 5. The cathode layer 1 is connected to a cathode current collector which is not shown, and the anode layer 3 is connected to an anode current collector which is not shown. Around the sealing material 5 and inside the exterior body 6, the water absorbent 7 is disposed in a manner that the electrode body 4 and the water absorbent 7 are in parallel to the lamination direction of each layer which configures the electrode 4. The heat insulating material 8 is disposed between the water absorbent 7 and the electrode body 4.

In the solid battery 10, since the heat insulating material 8 is disposed between the electrode body 4 and the water absorbent 7, even when the temperature of the electrode body 4 increases, it is possible to inhibit temperature increase of the water absorbent 7. Also, the electrode body 4 is easy to produce heat in the lamination direction of each layer which configures the electrode body 4. Therefore, by disposing the water absorbent 7 in a manner that the electrode body 4 and the water absorbent 7 are arranged in parallel in the lamination direction of each layer which configures the electrode body, temperature increase of the water absorbent 7 is easily inhibited.

As described above, with a decrease in temperature, the water absorption performance of the water absorbent increases. Therefore, inhibiting the temperature increase makes it possible to inhibit the degradation of the water absorption performance of the water absorbent. According to the solid battery 10, it is possible to inhibit the temperature increase of the water absorbent 7, thereby it is possible to inhibit the degradation of the water absorption performance of the water absorbent 7. Inhibiting the degradation of the water absorption performance of the water absorbent 7 enables water existing inside of the exterior body 6 to be easily absorbed to the water absorbent 7. Absorbing water by the water absorbent 7 makes it difficult for the solid electrolyte which configures the electrode body 4 and water to react to each other, thereby it becomes possible to inhibit the degradation of the solid battery 10. Therefore, according to the present invention, it is possible to provide the solid battery 10 which can inhibit degradation.

In the present invention, as the cathode active material to be contained in the cathode layer 1, a known active material that can be contained in a cathode layer of a lithium-ion secondary battery may be adequately used. Examples of such a cathode active material may include: layered active materials such as lithium cobalt oxide (LiCoO₂) and lithium nickel oxide (LiNiO₂); olivine type active materials such as olivine type lithium iron phosphate (LiFePO₄); spinel type active materials such as spinel type lithium manganese oxide (LiMn₂O₄) and the like. As the solid electrolyte to be contained in the cathode layer 1, a known solid electrolyte that can be contained in a cathode layer of a lithium-ion secondary battery may be adequately used. Examples of such a solid electrolyte may include: sulfide-based solid electrolytes such as Li₂S—P₂S₅ produced by mixing Li₂S and P₂S₅, and Li₃PS₄; oxide solid electrolytes such as Li₃PO₄; nitride solid electrolyte; halide solid electrolytes and the like. The configuration of the solid electrolyte to be contained in the cathode layer 1 is not particularly limited, and may be a crystalline solid electrolyte, an amorphous solid electrolyte, or a glass ceramic. In addition, the cathode layer 1 may also contain a binder to bond the cathode active material and the solid electrolyte, and an electrically conductive material to improve electrical conductivity. As the binder that can be contained in the cathode layer 1, styrene-butadiene rubber (SBR) and the like may be exemplified. As the electrically conductive material that can be contained in the cathode layer 1, a vapor-grown carbon fiber (VGCF. “VGCF” is a registered trademark of Showa Denko K.K. Same in what follows), carbon materials such as carbon black, and metallic materials that can endure the environment upon using a solid battery may be exemplified. Further, the thickness of the cathode layer 1 is not particularly limited and may be same as a thickness of a cathode layer of a known solid battery.

In the present invention, as the solid electrolyte to be contained in the solid electrolyte layer 2, a known solid electrolyte that can be used in a solid battery may be adequately used. As such a solid electrolyte, the solid electrolytes that can be contained in the cathode layer 1 mentioned above and the like may be exemplified. Also, the thickness of the solid electrolyte layer 2 is not particularly limited, and may be same as a thickness of a solid electrolyte layer of a known solid battery.

In the present invention, as the anode active material to be contained in the anode layer 3, a known active material that can be contained in an anode layer of a lithium-ion secondary battery may be adequately used. Examples of such an active material may include graphite and the like. As the solid electrolyte to be contained in the anode layer 3, a known solid electrolyte that can be contained in an anode layer of a lithium-ion secondary battery may be adequately used. Examples of such a solid electrolyte may include the solid electrolytes that can be contained in the cathode layer 1 mentioned above and the like. In addition, the anode layer 3 may also contain a binder to bond the anode active material and the solid electrolyte, and an electrically conductive material to improve electrical conductivity. As the binder and the electrically conductive material that can be contained in the anode layer 3, the binders and the electrically conductive materials that can be contained in the cathode layer 1 mentioned above may be exemplified. The thickness of the anode layer 3 is not particularly limited, and may be same as a thickness of an anode layer of a known solid battery.

In the present invention, as the sealing material 5, a laminate film and the like which are used when an electrode body of a lithium-ion secondary battery is sealed by reducing pressure may be adequately used. Examples of a material to compose such a laminate film may include: resin films such as polyethylene, polyvinyl fluoride, polyvinylidene chloride; metal vapor-deposited films in which metal such as aluminum is vapor-deposited onto the surface of these resin films and the like.

In the present invention, a material to compose the exterior body 6 is not particularly limited as long as the exterior body 6 is composed of a material which can endure the environment upon operation of the solid battery 10. The exterior body 6 may be made of a metal such as aluminum or stainless steel for example.

In the present invention, as the water absorbent 7, a known water absorbent that can absorb water existing inside the exterior body 6 at the time of using or storage of the solid battery 10, and can inhibit the degradation of the water absorption performance by inhibiting temperature increase may be adequately used. Examples of such a water absorbent may include molecular sieves (zeolite), silica gels, phosphorus pentoxide, barium oxide, calcium oxide, activated carbons and so on. Above all, for the solid battery 10, zeolite which also can absorb hydrogen sulfide is preferably used.

In the present invention, as the heat insulating material 8, a known heat insulating material which can reduce heat reaching from the electrode material 4 to the water absorbent 7 when the solid battery is in use may be adequately used. Examples of such a heat insulating material may include known glass wool, rock wool, urethane form and the like. In the present invention, in view of heat resistance and so on, it is preferable to use inorganic glass wool or rock wool.

In the present invention, as the cathode current collector connected to the cathode layer 1 and the anode current collector connected to the anode layer 3 may be composed of a known conductive material which can be used as an anode current collector and a cathode current connector of a lithium-ion secondary battery. As such a conductive material, a metallic material including at least one or more elements selected from the group consisting of Cu, Ni, Al, V, Au, Pt, Mg, Fe, Ti, Co, Cr, Zn, Ge, and In may be exemplified. Also, the cathode current collector and the anode current collector may be in a form of metallic foil, metallic mesh or the like for example.

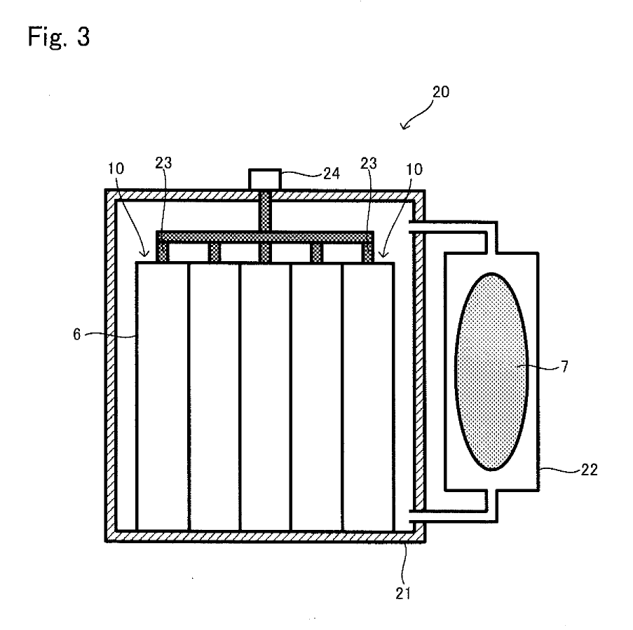

FIG. 3 is a view describing a solid battery 20 of the present invention according to the second embodiment (hereinafter sometimes referred to as “assembled battery 20”). Top-and-bottom direction of the drawing sheet of FIG. 3 is the lamination direction of each layer which configures the electrode body. In FIG. 3, the water absorbent 7 and the solid battery 10 are shown being simplified, and descriptions of some repeated reference numerous are omitted.

As shown in FIG. 3, the assembled battery 20 comprises a plurality of solid batteries 10, 10, . . . , an exterior body 21 which houses the solid batteries 10, 10, . . . , and a fluid circulation pathway 22 connected to the exterior body 21. A plurality of current collectors 23, 23, . . . are respectively extended from end faces of the solid batteries 10, 10, . . . , and the plurality of current collectors 23, 23, . . . are connected to a terminal 24 whose one end is placed outside the exterior 21. The terminal 24 is connected to the cathode layers 1, 1, . . . or the anode layers 3, 3, . . . via the current collectors 23, 23, . . . . The assembled battery 20, other than the terminal 24, has another terminal not shown and connected to the anode layers 3, 3, . . . or the cathode layers 1, 1, . . . via current collectors not shown.

As shown in FIG. 3, the fluid circulation pathway 22 is connected to the exterior body 21, and the water absorbent 7 is disposed inside the fluid circulation pathway 22. The fluid circulation pathway 22 is connected to the exterior body 21 in a configuration enabling a fluid (for example, preferably inert gas which does not degrade the battery performance (Ar gas, N₂ gas, and mixed gas thereof may be exemplified), same in what follows.) inside the exterior body 21 to flow into the fluid circulation pathway 22 and enabling the fluid which circulated in the fluid circulation pathway 22 to flow into the exterior body 21. The fluid circulation pathway 22 connected to the exterior body 21 is situated outside the exterior body 21 which houses the solid batteries 10, 10, . . . . For this reason, even if the temperature of the electrode bodies 4, 4, . . . is increased, the temperature in the fluid circulation pathway 22 is difficult to increase relatively. Hence, according to the assembled battery 20, it is possible to inhibit temperature increase of the water absorbent 7 disposed inside the fluid circulation pathway 22. Since the assembled battery 20 comprises the water absorbent 7 whose temperature increase is inhibited and thus the degradation of the water absorption performance is inhibited, it is possible to inhibit reaction between water and the solid electrolyte. Therefore, according to the second embodiment of the present invention, it is possible to provide the assembled battery 20 which can inhibit degradation.

Further, in the assembled battery 20, the water absorbent 7 is disposed outside the exterior body 21 (inside the fluid circulation pathway 22) as well. For this reason, even if the temperature inside the exterior 21 is increased on purpose in order to improve output power by reducing the resistance, the temperature of the water absorbent 7 disposed inside the fluid circulation pathway 22 is difficult to increase relatively. Therefore, according to the second embodiment of the present invention, it is possible to provide the assembled battery 20 which can inhibit degradation even when the battery is purposely heated to use.

In the assembled battery 20, a same material for the exterior body 6 may be used for the exterior 21 and the fluid circulation pathway 22.

Also, the current collector 23 may be composed of a known conductive material which can be used as a current collector of a lithium-ion secondary battery. As such a conductive material, a metallic material including at least one or more elements selected from the group consisting of Cu, Ni, Al, V, Au, Pt, Mg, Fe, Ti, Co, Cr, Zn, Ge, and In may be exemplified. The current collector 23 may be in a form of metallic foil, metallic mesh or the like for example.

The terminal 24 may be composed of a same material for the current collector 23.

As described above, in the assembled battery 20, the temperature in the fluid circulation pathway 22 is more difficult to increase than the temperature in the exterior body 21. Therefore, it is considered that fluid can be circulated inside the exterior body 21 and the fluid circulation pathway 22 without using a device to circulate fluid. A device to circulate fluid is not shown in FIG. 3, but the second embodiment of the present invention is not limited to the configuration in which a device to circulate fluid is not used. In view of making a configuration in which the solid electrolyte and water are difficult to react to each other by a configuration in which fluid is easy to circulate to improve the water absorption efficiency of the water absorbent 7 disposed inside the fluid circulation pathway 22 and the like, it is possible to dispose a device to circulate fluid (for example, a known pump and so on) in the exterior body 21 or the fluid circulation pathway 22.

In the above description regarding the assembled battery 20, a configuration in which the heat insulating material 8 is disposed inside the exterior body 6 was shown as an example, but the second embodiment of the present invention in which the water absorbent 7 is disposed inside the fluid circulation pathway 22 is not limited to this configuration. The heat insulating material 8 may be disposed only outside the exterior 6 (for example, inside the fluid circulation pathway 22), and may be disposed inside and outside the exterior body 6.

Further, in the above description regarding the assembled battery 20, a configuration in which the water absorbent 7 was disposed inside the exterior body 6 and inside the fluid circulate pathway 22 was shown as an example, but the water absorbent 7 can be disposed outside the exterior body 6 and inside the exterior body 21, or only inside the fluid circulation pathway 22.

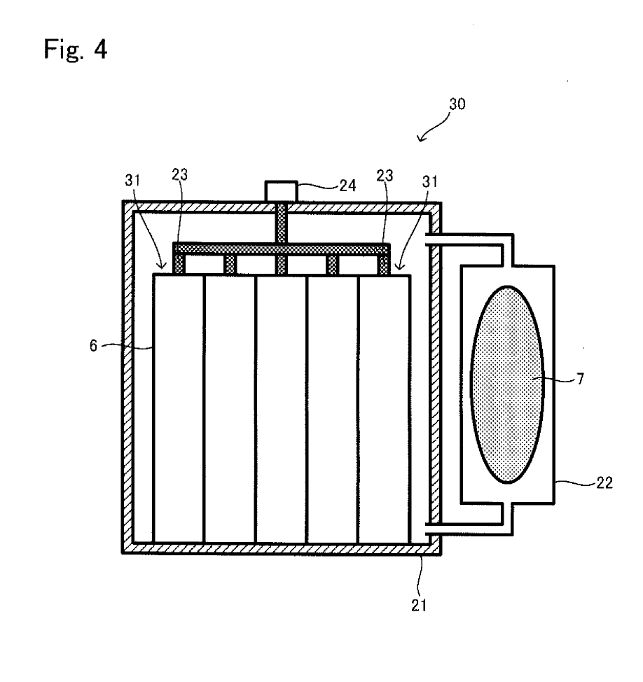

FIG. 4 is a view describing a solid battery 30 of the present invention according to the third embodiment (hereinafter sometimes referred to as “assembled battery 30”). Top-and-bottom direction of the drawing sheet of FIG. 4 is the lamination direction of each layer which configures the electrode body. In FIG. 4, the water absorbent 7 and the solid battery 31 are shown being simplified and descriptions of some repeated reference numerous are omitted. In FIG. 4, to the same structure as those in the solid battery 10 and the assembled battery 20, the same reference numerals as those used in FIG. 2 and FIG. 3 are given and the explanation thereof is arbitrarily omitted.

As shown in FIG. 4, the assembled battery 30 comprises a plurality of solid batteries 31, 31, . . . , the exterior body 21 which houses the solid batteries 31, 31, . . . , and the fluid circulation pathway 22 connected to the exterior body 21. The solid battery 31 has a same configuration as that of the solid battery 10 except that a heat insulating material and a water absorbent are not disposed inside the exterior body 6. Each of the current collectors 23, 23, . . . is extended from an end face of each of the solid batteries 31, 31, . . . , and the plurality of current collectors 23, 23, . . . are connected to the terminal 24 whose one end is placed outside of the exterior 21. The terminal 24 is connected to the cathode layers 1, 1, . . . or the anode layers 3, 3, . . . via the current collectors 23, 23, . . . . The assembled battery 30, other than the terminal 24, has another terminal not shown and connected to the anode layers 3, 3, . . . or the cathode layers 1, 1, . . . via current collectors not shown.

As shown in FIG. 4, the fluid circulation pathway 22 is connected to the exterior body 21, and the water absorbent 7 is disposed inside the fluid circulation pathway 22. The fluid circulation pathway 22 is connected to the exterior body 21 in a configuration which enables the fluid inside the exterior body 21 to flow into the fluid circulation pathway 22 and enables the fluid which circulated inside the fluid circulation pathway 22 to flow into the exterior body 21. The fluid circulation pathway 22 connected to the exterior body 21 is located outside the exterior body 21 which houses the solid batteries 31, 31, . . . . For this reason, even if the temperature of the electrode bodies 4, 4, . . . is increased, the temperature in the fluid circulation pathway 22 is difficult to increase relatively. Hence, according to the assembled battery 30, it is possible to inhibit temperature increase of the water absorbent 7 disposed inside the fluid circulation pathway 22. Since the assembled battery 30 comprises the water absorbent 7 whose temperature increase is inhibited and thus the degradation of the water absorption performance is inhibited, it is possible to inhibit reaction between water and the solid electrolyte. Therefore, according to the third embodiment of the present invention, it is possible to provide the assembled battery 30 which can inhibit degradation.

Further, as with the assembled battery 20, in the assembled battery 30, the water absorbent 7 is disposed outside the exterior body 21 (inside the fluid circulation pathway 22). For this reason, even if the temperature in the exterior body 21 is increased on purpose in order to improve output power by reducing the resistance, the temperature of the water absorbent 7 disposed inside the fluid circulation pathway 22 is difficult to increase relatively. Therefore, according to the third embodiment of the present invention, it is possible to provide the assembled battery 30 which can inhibit degradation even when the battery is purposely heated to use.

In the above description regarding the present invention, a configuration in which the water absorbent 7 and the electrode body 4 are disposed in a manner to be in parallel to the lamination direction of each layer which configures the electrode body 4 was shown, but the present invention is not limited to this configuration. However, in view of making a configuration in which degradation of the battery is easily inhibited by inhibiting the temperature increase of the water absorbent 7, the configuration in which the water absorbent 7 and the electrode body 4 are disposed in a manner to be in parallel to the lamination direction of each layer which configures the electrode body 4 is preferable.

Further, in the above descriptions regarding the present invention, a configuration in which one electrode body 4 is housed in the exterior body 6 has been shown. However, the present invention is not limited to this configuration. The exterior body made of a laminate film and the like may house a plurality of electrode bodies connected electrically in series or in parallel.

Moreover, in the above description regarding the present invention, a configuration in which the solid battery is a lithium-ion secondary battery has been shown. However, the present invention is not limited to this configuration. The solid battery of the present invention can be configured such that ions other than lithium ion move between the cathode layer and the anode layer. Examples of such ions may include a sodium ion, a potassium ion and so on. When the configuration in which ions other than lithium ions move is adopted, the cathode active material, the solid electrolyte, and the anode active material may be adequately selected depending on the ions to move.

The solid battery of the present invention was made and the performance was evaluated. The method for manufacturing the solid battery and the result of the performance evaluation were shown below.

### <Preparation of a Solid Electrolyte>

Li₂S (manufactured by Nippon Chemical Industrial) and P₂S₅ (manufactured by Aldrich) were used as starting ingredients, and 0.7656 g of Li₂S and 1.2344 g of P₂S₅ were weighed. Next, the weighed ingredients were mixed in an agate mortar for 5 minutes. After that, 4 g of heptane was added to the mixture and mechanical milling was carried out using a planetary ball mill for 40 hours, thereby Li₂S—P₂S₅ as a sulfide-based solid electrolyte was prepared.

### <Production of an Electrode Material>

### A Cathode Composite (an Electrode Material)

A cathode composite was obtained by mixing weighed 12.03 mg of a cathode active material (LiNi_{1/3}Co_{1/3}Mn_{1/3}O₂, manufactured by Nichia Corporation), 0.51 mg of VGCF (manufactured by Showa Denko K.K.), and 5.03 mg of the solid electrolyte (Li₂S—P₂S₅) prepared by the above step.

### An Anode Composite (an Electrode Material)

An anode composite was obtained by mixing weighed 9.06 mg of an anode active material (graphite, manufactured by Mitsubishi Chemical Corporation) and 8.24 mg of the solid electrolyte (Li₂S—P₂S₅) prepared by the above step.

### <Production of an Electrode Body>

In a mold having an open portion of 1 cm² capable of filling materials, 18 mg of the solid electrolyte (Li₂S—P₂S₅) prepared in the above step was weighed and filled, then pressed at a pressure of 100 MPa thereby a solid electrolyte layer was made. After that, 17.57 mg of the cathode composite mentioned above was disposed to one side of the solid electrolyte layer and pressed at a pressure of 100 MPa, thereby a cathode layer was made. Then, 17.3 mg of the anode composite mentioned above was disposed to the other side of the solid electrolyte layer (the side where the cathode composite was not disposed), and pressed at a pressure of 400 MPa, thereby an anode layer was made. Accordingly, a laminated body having a pair of a cathode layer and an anode layer, and a solid electrolyte layer disposed between the cathode layer and the anode layer was produced. After that, an electrode body was made by sandwiching the laminated body by a pair of current collectors (SUS304).

### Production of a Solid Battery

### Reference Example 1

A solid battery according to the Reference Example 1 was produced by: putting 25 g of a water absorbent (Molecular Sieves 3A, manufactured by Nacalai Tesque, INC.) subjected to vacuum drying at a temperature of 280° C. for 8 hours and the electrode body produced as mentioned above in a 200 ml container made by glass in which a dew-point meter was attached in advance, in a way that the electrode body and the water absorbent were disposed in parallel to the lamination direction of each layer which configures the electrode body; and sealing off the container.

### Reference Example 2

A solid battery according to the Reference Example 2 was made in the same way as in the solid battery according to the Reference Example 1, except that 25 g of a water absorbent (Molecular Sieves 3A, manufactured by Nacalai Tesque, INC.) subjected to air drying at a temperature of 60° C. for 8 hours was used.

### <Measuring Dew Point>

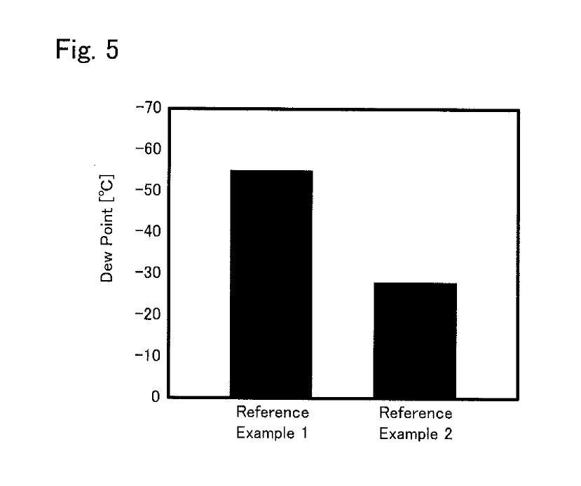

With respect to the solid batteries according to the Reference Examples 1 and 2, dew points in the containers under a temperature of 60° C. after 24 hours passed were measured. The results were shown in FIG. 5. The vertical axis of FIG. 5 represents dew point [° C.].

As shown in FIG. 5, the dew point inside the container of the solid battery according to the Reference Example 1 was −55° C., and the dew point inside the container of the solid battery according to the Reference Example 2 was −28° C.

### <Evaluation of Cycle Characteristic>

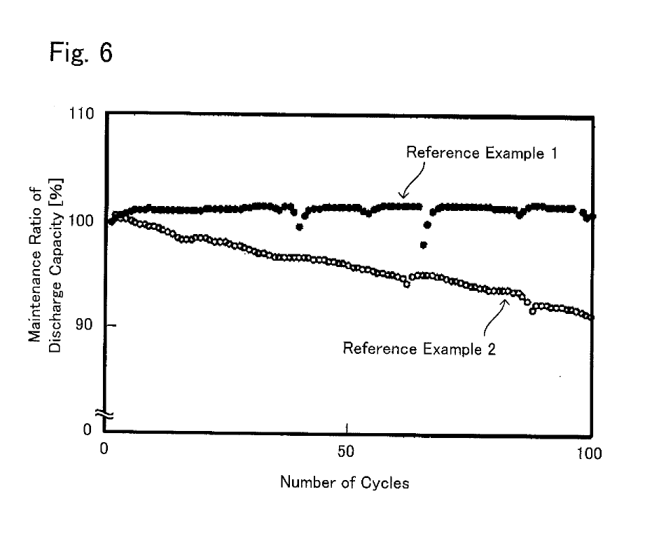

Under a temperature of 60° C., each of the solid batteries according to the Reference Example 1 and 2 was charged with a constant current of 3.44 mA up to 4.2 V and then discharged down to 2.5 V. Counting this charging and discharging as one cycle, and the cycle characteristic was evaluated by repeating the cycle for 100 times. The results are shown in FIG. 6. The vertical axis represents maintenance ratio of discharge capacity [%], and the horizontal axis represents number of cycles.

As shown in FIG. 6, the solid battery according to the Reference Example 1 which has a low dew point in the container had a higher maintenance ratio of discharge capacity and showed a better cycle characteristic than that of the solid battery according to the Reference Example 2 which has a high dew point in the container. From this result, it was confirmed that degradation of the solid battery can be inhibited by inhibiting the degradation of the water absorbent performance of the water absorbent.

The present invention has been described above as to the embodiments which are supposed to be practical as well as preferable at present. However, it should be understood that the present invention is not limited to the embodiments disclosed in the specification of the present application and can be appropriately modified within the range that does not depart from the gist or spirit of the invention, which can be read from the appended claims and the overall specification, and that a solid battery with such modifications is also encompassed within the technical range of the present invention.

### DESCRIPTION OF THE REFERENCE NUMERALS

1 cathode layer
2 solid electrolyte layer
3 anode layer
4 electrode body
5 sealing material
6, 21 exterior body
7 water absorbent
8 heat insulating material
10, 31 solid battery
20, 30 assembled battery (solid battery)
22 fluid circulation pathway
23 current collector
24 terminal

1. A solid battery comprising: an electrode body having a pair of electrode layers and a solid electrolyte layer disposed between the pair of electrode layers;
and an exterior body which houses the electrode body, wherein a water absorbent is provided inside the exterior body, and a heat insulating material is disposed between the water absorbent and the electrode body.

2. The solid battery according to claim 1, wherein the water absorbent and the electrode body are disposed in a manner to be in parallel to a lamination direction of each layer which configures the electrode body.

3. The solid battery according to claim 1, wherein a fluid circulation pathway is connected to the exterior body, a fluid circulates inside the exterior body and the fluid circulation pathway, and a water absorbent is disposed inside the fluid circulation pathway.

4. A solid battery comprising: an electrode body having a pair of electrode layers and a solid electrolyte disposed between the pair of electrode layers; and an exterior body which houses the electrode body, wherein a fluid circulation pathway is connected to the exterior body, a fluid circulates inside the exterior body and the fluid circulation pathway, and a water absorbent is disposed inside the fluid circulation pathway.

5. The solid battery according to claim 1, wherein the solid electrolyte layer contains a sulfide-based solid electrolyte.

6. The solid battery according to claim 2, wherein a fluid circulation pathway is connected to the exterior body, a fluid circulates inside the exterior body and the fluid circulation pathway, and a water absorbent is disposed inside the fluid circulation pathway.

7. The solid battery according to claim 2, wherein the solid electrolyte layer contains a sulfide-based solid electrolyte.

8. The solid battery according to claim 3, wherein the solid electrolyte layer contains a sulfide-based solid electrolyte.

9. The solid battery according to claim 6, wherein the solid electrolyte layer contains a sulfide-based solid electrolyte.

10. The solid battery according to claim 4, wherein the solid electrolyte layer contains a sulfide-based solid electrolyte.
